(19) United States
(12) Patent Application Publication
(10) Pub. No.: US 2024/0422544 A1
(43) Pub. Date: Dec. 19, 2024

(54) Methods and systems for dataflow control in low power wide area networks

(71) Applicant: Everynet Oy, Espoo (FI)

(72) Inventor: Vitaly Kleban, Espoo (FI)

(21) Appl. No.: 18/703,384

(22) PCT Filed: Oct. 20, 2022
(86) PCT No.: PCT/FI2022/050698

§ 371 Date: Apr. 22, 2024

Related U.S. Application Data
(60) Provisional application No. 63/257,589, filed on Oct. 20, 2021.

(51) Int. Cl. H04W 12/106; H04L 9/08; H04L 49/552

(52) U.S. Cl. CPC H04W 12/106; H04L 9/0894; H04L 49/552

(57) ABSTRACT

Methods and systems for dataflow control in low power wide area networks (LPWAN) comprising at least a data source, operator and client. The systems and methods: calculating, within the data source, a message integrity code (MIC) based at least on a secret key K, data compiled by the data source, and a data source identifier (ID); transmitting, from the data source to the operator, a message comprising at least the message integrity code (MIC), the data source identifier (ID) and the data; transmitting, from the client to the operator, a subscription request comprising the data source identifier (ID); transmitting, from the operator to the client, a request comprising: the data source identifier (ID), the data, and a set of integrity codes comprising the message integrity code (MIC) and at least one fake integrity code; and transmitting, from the client to the operator, a response comprising an indication of the presence, position, or value of the message integrity code within the set of integrity codes.

### BACKGROUND

Low power wide area networks (LPWAN) use messages to communicate between parties. Sometimes messages are also called packets or datagrams. However, once a message is transmitted to the radio spectrum it becomes publicly available as anyone could potentially receive it. As such, malicious actors may capture messages and possibly modify and relay such modified messages.

While certain message integrity techniques are used within LPWAN in order to ensure that messages have not been corrupted due to interference in the radio spectrum, there remains a problem on how to control access and manage the flow of data in LPWAN settings.

### SUMMARY OF THE INVENTION

The invention is defined by the features of the independent claims. Some specific embodiments are defined in the dependent claims.

According to a first aspect of the present invention, there is provided an operator of a low power wide area network (LPWAN), the operator comprising at least one processing core, at least one memory including computer program code, the at least one memory and the computer program code being configured to, with the at least one processing core, cause the operator at least to: receive a subscription request from a client, the subscription request comprising a data source identifier (ID); receive a message comprising the data source identifier (ID), data, and a message integrity code (MIC); transmit a request to the client, the request comprising, the data source identifier (ID), the data, and a set of integrity codes comprising the message integrity code (MIC) and at least one fake integrity code; and receive a response from the client comprising an indication of the presence, position, or value of the message integrity code within the set of integrity codes.

According to a second aspect of the present invention, there is provided a client of a low power wide area network (LPWAN), the client comprising at least one processing core, at least one memory including computer program code, the at least one memory and the computer program code being configured to, with the at least one processing core, cause the client at least to: store a set of at least one data source identifier (ID) and an associated secret key (K); send a subscription request to an operator comprising a data source identifier (ID); receive a request from the operator comprising a set of integrity codes; calculate a message integrity code based at least on the secret key (K) associated with the data source identifier (ID), and the content of the request; and transmit a response to the operator comprising an indication of the presence, position or value of the message integrity code within the set of integrity codes.

According to a third aspect of the present invention, there is provided a data source of a low power wide area network (LPWAN), the data source comprising at least one processing core, at least one memory including computer program code, the at least one memory and the computer program code being configured to, with the at least one processing core, cause the data source at least to: store a secret key, K and a data source identifier (ID); compile data; calculate a message integrity code based at least on the secret key K, the data and the data source identifier (ID); and transmit a message comprising at least the message integrity code (MIC), the data source identifier (ID) and the data.

According to a fourth aspect of the present invention there is provided a system for dataflow control in a low power wide area network (LPWAN), the system comprising at least a data source, operator and client, each of said data source, operator and client comprising at least one processing core, at least one memory including computer program code, the at least one memory and the computer program code being configured to, with the at least one processing core, cause the system at least to: calculate, within the data source, a message integrity code (MIC) based at least on a secret key K, data compiled by the data source, and a data source identifier (ID); transmit, from the data source to the operator, a message comprising at least the message integrity code (MIC), the data source identifier (ID) and the data; transmit, from the client to the operator, a subscription request comprising the data source identifier (ID); transmit, from the operator to the client, a request comprising: the data source identifier (ID), the data, and a set of integrity codes comprising the message integrity code (MIC) and at least one fake integrity code; and transmit, from the client to the operator, a response comprising an indication of the presence, position, or value of the message integrity code within the set of integrity codes.

### BRIEF DESCRIPTION OF THE DRAWINGS

FIG. 1 illustrates a LPWAN system in accordance with at least some embodiments of the present invention;

FIG. 2 illustrates the same system with a bad actor, or hacker, imposed within the system, and

FIG. 3 illustrates an example apparatus capable of supporting at least some embodiments of the present invention.

### EMBODIMENTS

As wireless networks continue to develop, the trend is towards networks with ever-increasing bandwidth. With these ever-increasing bandwidths come ever-increasing complexity and power demands. However, many applications can be found for low power and lower bandwidth solutions, for example Low Power Wide Area Networks (LPWAN), networks that could operate at 300 bps as opposed to 300 Mbps.

LPWAN applications require lighter and more resource conscious solutions. For example, dataflow control, the process of determining which data should be sent where under various rights and restriction schemes, should be implemented in as resource efficient a fashion as possible. Embodiments of the present invention provide for such resource efficient data flow control.

Embodiments of the present invention employ message integrity codes in order to control dataflow or control access to information. Within embodiments of the present invention, not only may message integrity codes, MICs, be used to guarantee that a message has not been corrupted, but they are also employed to control dataflow.

Within certain embodiments of the present invention, LPWAN operators capture messages from the radio spectrum and forward messages to clients based on an ID field of the messages. Operators typically do not have access to the corresponding cryptographic keys and are unable to calculate and verify message integrity codes of the messages. At the same time, the operator would like to make sure that it forwards messages to the real owner of the messages without gaining any knowledge about the cryptographic keys at least due to the fact that gaining knowledge of the cryptographic keys would be an additional and often unwanted responsibility for the operator. Embodiments of the present invention provide for a novel method of dataflow control that does not require an operator to know any cryptographic keys, but still allow for assurance that the source of the data is legitimate and the receiver of the data has rights to receive such data.

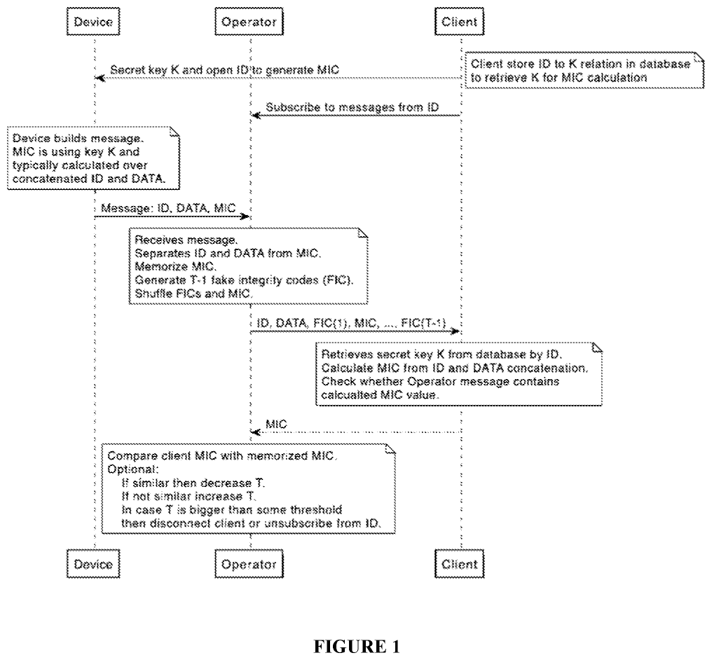

According to certain embodiments of the present invention, message integrity codes employed by LPWAN solutions are used to control dataflow. One such embodiment is shown in FIG. 1 illustrating an LPWAN comprising a data source device, operator and client.

Starting from the top of the figure, there is an illustrated a step according to at least some embodiments wherein the source device is provisioned with a secret key K and an open ID, or data source ID, by the client. In other embodiments, the source device is provisioned with at least one of the open ID and secret key K during manufacture. Regardless, the client stores the source ID and associated secret key K for the source device so as to be able to calculate a message integrity code (MIC) based at least on the secret key K and transmitted data.

As seen, the source device calculates a message integrity code (MIC) based at least on a secret key K, data compiled by the data source, and a data source identifier (ID). In the embodiment illustrated, this MIC is calculated using, K and a concatenation of the DATA and ID, but other calculation methods are possible as will be discussed below.

After calculating the message integrity code (MIC) the source device transmits a message to the operator. The message comprising at least the message integrity code (MIC), the data source identifier (ID) and the data.

As shown in the second leftward facing arrow in FIG. 1, the client transmits a subscription request comprising the data source identifier (ID) to the operator. In response to such a subscription request, the operator transmits to the client, a request comprising: the data source identifier (ID), the data, and a set of integrity codes comprising the message integrity code (MIC) and at least one fake integrity code (FIC). The number of FIC codes may be varied based upon a level of trust as will be discussed below.

As can be seen, in the illustrated embodiment and others, the request transmitted from the operator including the fake integrity codes already includes the data. In effect, the operator has responded to the subscription request by starting the stream of data. Included in this stream of data is the set of integrity codes that require a response in order to for the client to remain subscribed to the stream as discussed below.

Responsive to the request of the operator, the client transmits a response to the operator comprising an indication of the presence, position, or value of the message integrity code within the set of integrity codes. In certain embodiments, such an indication can be as simple as a yes or no when the client is only expected to identify if the true MIC was present in order to prove they are the owner of the data. In other embodiments, the client may respond with a location of the true MIC within the set of integrity codes. For example, the client may respond, 1 if the MIC is the first integrity code within the set. Still other embodiments involve the client responding with an array of yes/no or true/false answers. Such an array response would allow the client to inform the operator the true (real MIC) or false (FIC) nature of each integrity code in a set of received integrity codes. This allows, for example, for the operator to include two instances of the real MIC in order to further increase security should the operator lack trust in a potential client and feel the client may just be guessing the MIC. Within at least some embodiments, the order of integrity codes within the set of integrity codes is randomized.

As finally illustrated in FIG. 1, the operator uses the client's response to the operators request to adjust a trust level T. As illustrated, within at least some embodiments the trust level is adjusted based on the response from the client. For example, as illustrated, an incorrect response may result in the trust level T, sometimes referenced as N to avoid confusion, is increased. As T or N are used to calculate a number of fake integrity codes (FICs), increasing T or N results in it being harder for a client to guess the correct MIC. For example, within certain embodiments, the number of fake integrity codes within the set of integrity codes is based on a trust level (N) associated with at least one of: the data source and the client. In such embodiments, the operator may have a database containing associations between, for example, client and source devices. In certain instances, a source device may have multiple owners or associated clients. These associations would then be used to establish trust levels.

In at least some embodiments, the trust level (N) is adjusted based on analysis of client responses. In certain embodiments, the trust level is adjusted randomly, thus making it harder to predict the required responses. In other embodiments, an analysis of responses may lead the operator to feel that a client is just good at guessing and thus a number of FICs or trust level (N) is drastically increased. For example, within certain embodiments, the trust level (N) is an integer, greater than 1, and the number of fake integrity codes is equal to N-1.

Within certain embodiments, the trust level (N) has a maximum value (M), and if N is increased above M, the client is unsubscribed from the data source. In other embodiments, the client may be banned entirely or temporarily suspended, for example for 24 hours. According to some embodiments, unsubscription entails being blocked from a particular device ID, or even blocked from all device IDs, or perhaps blocked in general.

In certain embodiments trust level N is increased if the response from the client comprises an incorrect indication of the presence, position or value of the message integrity code and N is decreased if the response from the client comprises a correct indication of the presence, position or value of the message integrity code. It should be noted that no response at all to an operators request can be considered an incorrect response in at least some embodiments.

In embodiments employing an adaptive trust system, for example the trust level embodiments described above, the level of trust depends on the client's ability to successfully prove ownership over the message. Such adaptive trust provides advantages as a system which allows for providing a large number of fake MICs provides for an opportunity for an operator to guess the true MIC. For example, if an operator were a bad actor attempting to spoof sensor data, they could transmit the data and attempt to guess the MIC. If the system allows for 100 000 integrity codes within a set, the operator would have 1 out of 100 000 chance to guess the correct MIC. Even worse, in systems that provide for a client to respond with the correct MIC, such guessing allows the operator to confirm a correct guess once they receive a response from the client. However, such a confirmation of a guessed MIC can be avoided as discussed herein by employing a system whereby the client responds not with an indication of the exact MIC, but with an indication that the MIC is present or not in a set of integrity codes.

Given adaptive trust, at least some embodiments provide for the trust level to start at N=2048. In embodiments where N is halved for each correct response and doubled for each incorrect response, “complete” trust could then be established in 11 responses.

While a number of steps are illustrated within FIG. 1, not all are necessary in every embodiment of the claimed invention. Further, the order of steps illustrated need not been followed in all embodiments of the invention.

In at least some embodiments of the claimed invention, the client calculates a message integrity code (MIC) based at least on the secret key K associated with the data source identifier (ID), and the content of the request received from the operator. In certain embodiments, the client stores a set of at least one data source identifier (ID) and an associated secret key, K. The data source identifier(s) being associated with specific data source devices in some embodiments. As mentioned, in certain embodiments of the present invention, the client provisions the data source with the secret key (K) and the data source identifier (ID).

According to at least some embodiments of the present invention, each message contains at least the following fields:
ID-identifier of the cryptographic key used to generate MIC;
DATA-some message data that may consist of some other fields or be empty;
MIC-message integrity code that is typically calculated over concatenation of ID and DATA parts.

System and methods according to the present invention were described above as a whole; the various components of the LPWAN will be described individually in the following paragraphs.

At least some embodiments of the present invention provide for methods in operators of low power wide area networks or operators themselves, sometimes operator devices or apparatuses, which complete the following steps, not necessarily in order. An operator will receive a subscription request from a client, such as a client device or apparatus, for example a cell phone, tablet, laptop, computer or other personal device. The subscription request comprising a data source identifier (ID). The operator also receives a message comprising the data source identifier (ID), data, and a message integrity code (MIC). In at least some embodiments, this message is sent from a data source or data source device such as a sensor or monitor. Further examples of data sources include devices configured to provide: contact tracing, gas, water or energy consumption monitoring, vending machine monitoring, panic button functionality, remote ordering, asset tracking, fleet and cargo tracking and hygiene monitoring.

The operator also transmits a request to the client, the request comprising, the data source identifier (ID), the data, and a set of integrity codes comprising the message integrity code (MIC) and at least one fake integrity code. The operator then receives a response from the client comprising an indication of the presence, position, or value of the message integrity code within the set of integrity codes. In at least some embodiments, the request is encrypted.

Within certain embodiments of the present invention, the operator is configured to randomize an order of the integrity codes within the set of integrity codes.

In some embodiments, the number of fake integrity codes within the set of integrity codes is based on a trust level (N) associated with at least one of: the data source and the client. In such embodiments, the operator will have a database comprising associations between clients and source devices. Some source devices may have shared ownership such that they are associated with multiple clients.

At least some operators according to the present invention are configured to change a trust level (N) based on the response received from the client. Within certain embodiments, the trust level (N) is increased if the received response from the client comprises an incorrect indication of the presence, position or value of the message integrity code, or decreased if the received response from the client comprises a correct indication of the presence, position or value of the message integrity code. In certain embodiments, no response is considered an incorrect indication. In at least some embodiments, the trust level (N) is an integer, greater than 1 and the number of fake integrity codes is equal to N-1. While in certain embodiments, the trust level (N) has a maximum value (M) and if N is increased above M the client is unsubscribed from the data source or the client is banned entirely.

In some embodiments, the indication of the presence, position or value of the message integrity code within the set of integrity codes comprises the message integrity code itself. While in certain embodiments, the indication of the presence, position or value of the message integrity code within the set of integrity codes comprises a location of the message integrity code within the set of integrity codes.

At least some operators according to the present invention are configured to operator using the LoRaWAN protocol. While some operators are configured to operate in a rebroadcast mode, where all received data is rebroadcasted, encrypted, to all clients whereby the client can use their ability to calculate the real MIC to determine which data is theirs.

At least some embodiments of the present invention provide for methods in clients of low power wide area networks or clients themselves, sometimes client devices or apparatuses, which complete the following steps, not necessarily in order. A client will store a set of at least one data source identifier (ID) and an associated secret key (K). Within at least some embodiments, the clients are configured to provision each source device with its own secret key and, in some instances, device ID. The client sends a subscription request to an operator comprising a data source identifier (ID) and receives a request from the operator comprising a set of integrity codes. The client calculates a message integrity code based at least on the secret key (K) associated with the data source identifier (ID), and the content of the request; and transmits a response to the operator comprising an indication of the presence, position or value of the message integrity code within the set of integrity codes. According to certain embodiments, the request comprises the data source identifier (ID), the data, and the set of integrity codes. Within certain embodiments, the indication of the presence, position or value of the message integrity code within the set of integrity codes comprises the message integrity code itself. In some embodiments, the indication of the presence, position or value of the message integrity code within the set of integrity codes comprises a location of the message integrity code within the set of integrity codes, for example an index of an array or matrix.

At least some embodiments of the present invention provide for methods in data sources of low power wide area networks or data sources themselves, sometimes data source devices or apparatuses, which complete the following steps, not necessarily in order. The data source stores a secret key, K and a data source identifier (ID); compiles data; calculates a message integrity code based at least on the secret key K, the data and the data source identifier (ID); and transmits a message comprising at least the message integrity code (MIC), the data source identifier (ID) and the data. At least some data sources are provisioned the secret key, K and the data source identifier (ID) for storing, for example from a client device. At least some source devices according to embodiments the present invention have a maximum bandwidth of between 100 bits per second to 10 000 bits per second.

Embodiments of the present invention may employ message integrity codes (MIC) similar to those used in LoRaWAN and Sigfox wireless communication protocols. Message integrity codes may act, in certain embodiments, similar to a checksum (such as CRC32), except that they prevent intentional tampering with a message by using a cryptographic key, called a NwkSKey in LoRaWAN. There are different algorithms to calculate message integrity codes, for example, AES-CMAC is widely used, specifically in LoRaWAN.

In at least some embodiments of the present invention employ a message the cipher-based message authentication code (CMAC) algorithm in order to calculate a MIC. For example, based on the following formula, where K is the secret key and data is the data transmitted:

$$M I C = aes 128 \_cmac ( K , DATA )$$

In certain embodiments, the MIC is calculated based on a CMAC algorithm which is used on a combination of the secret key K and a concatenation of the ID and DATA as illustrated in the following formula:

$$M I C = aes 128 \_cmac ( K , ID DATA )$$

At least some embodiments employ the CMAC algorithm as described in the RFC4492, available at the following URL: https://www.ietf.org/rfc/rfc4493.html

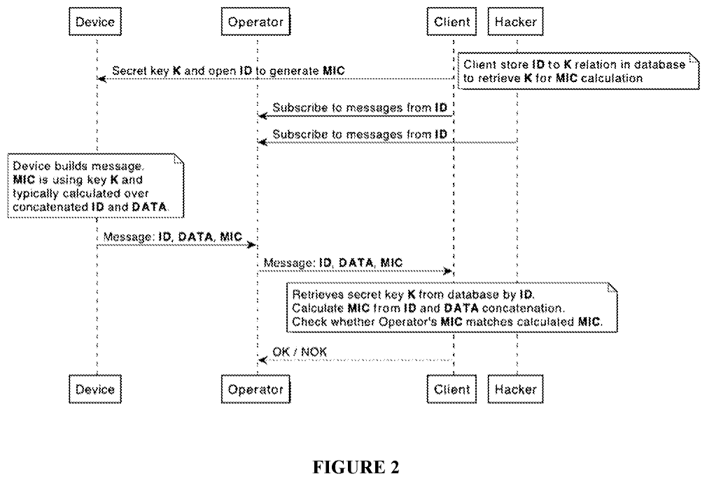

FIG. 2, illustrates an example LPWAN system including a hacker who is attempting to subscribe to messages that the hacker does not own. The system of FIG. 2 functions in the same fashion as the system of FIG. 1, however, here there is the malicious actor, the hacker, who has sent a subscription request to the operator. AS illustrated, this request would be, in most embodiments, identical to the subscription request sent by the true owner, the client. In response to such subscription requests the operator would, in at least some embodiments, begin to forward requests to both the client and the hacker. As shown, it is only the client, who can determine the real MIC based on their knowledge of the secret key K associated with the ID subscribed, who can respond to the operator's requests correctly.

In at least some embodiments of the system illustrated within FIG. 2, the incorrect response from the hacker, which in certain embodiments includes no response, would result in no further requests being sent to the hacker from the operator. As such, no further data would be forwarded to the hacker. In other embodiments, requests from the operator to the hacker would continue until a threshold was reached. For example, after the first incorrect response from the hacker, the operator could increase a complexity of the request by, for example, increasing a number of fake integrity codes in the request.

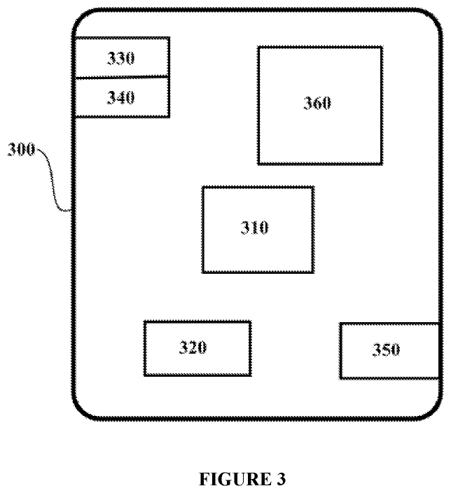

FIG. 3 illustrates an example apparatus capable of supporting at least some embodiments of the present invention. Illustrated is device 300, which may comprise, for example: any of the participants in the LPWAN systems discussed herein, such as: a client device, operator device or data source device. Comprised in device 300 is processor 310, which may comprise, for example, a single- or multi-core processor wherein a single-core processor comprises one processing core and a multi-core processor comprises more than one processing core. Processor 310 may comprise a Qualcomm Snapdragon 800 processor, for example. Processor 310 may comprise more than one processor. A processing core may comprise, for example, a Cortex-A8 processing core manufactured by Intel Corporation or a Brisbane processing core produced by Advanced Micro Devices Corporation. Processor 310 may comprise at least one application-specific integrated circuit, ASIC. Processor 310 may comprise at least one field-programmable gate array, FPGA. The aforementioned processor types are non-limiting examples, alternatively an Intel i7 processor, or another suitable type of processor, may be employed.

Device 300 may comprise memory 320. Memory 320 may comprise random-access memory and/or permanent memory. Memory 320 may comprise at least one RAM chip. Memory 320 may comprise magnetic, optical and/or holographic memory. Memory 320 may be at least in part accessible to processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions.

Device 300 may comprise a transmitter 330. Device 300 may comprise a receiver 340. Transmitter 330 and receiver 340 may be configured to transmit and receive, respectively, information in accordance with systems, for example, transmitter 330 may transmit information to a monitor for display to a user, and/or receiver 340 may receive input information concerning a location and/or orientation of a further device.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard and a touchscreen. A user may be able to operate device 300 via UI 360, for example to start or terminate execution of programs.

Processor 310 may be furnished with a transmitter arranged to output information from processor 310, via electric leads internal to device 300, to other devices comprised in device 300. Such a transmitter may comprise a serial bus transmitter arranged to, for example, output information via at least one electric lead to memory 320 for storage therein. Alternatively, to a serial bus, the transmitter may comprise a parallel bus transmitter. Likewise, processor 310 may comprise a receiver arranged to receive information in processor 310, via electrical leads internal to device 300, from other devices comprised in device 300. Such a receiver may comprise a serial bus receiver arranged to; for example, receive information via at least one electric lead from receiver 340 for processing in processor 310. Alternatively, to a serial bus, the receiver may comprise a parallel bus receiver.

Device 300 may comprise further devices not illustrated in FIG. 3. For example, where device 300 comprises a computer device, it may comprise at least one clock or auxiliary power unit, APU to provide battery power in case of mains power failure.

Processor 310, memory 320, transmitter 330, receiver 340, NFC transceiver 350 and/or UI 360 may be interconnected by electric leads internal to device 300 in a multitude of different ways. For example, each of the aforementioned devices may be separately connected to a master bus internal to device 300, to allow the devices to exchange information. However, as the skilled person will appreciate, this is only one example and depending on the embodiment, various ways of interconnecting at least two of the aforementioned devices may be selected without departing from the scope of the present invention.

At least some embodiment of the present invention provide for the following clauses:

19. A system for dataflow control in a low power wide area network (LPWAN), the system comprising at least a data source, operator and client, each of said data source, operator and client comprising at least one processing core, at least one memory including computer program code, the at least one memory and the computer program code being configured to, with the at least one processing core, cause the system at least to:
calculate, within the data source, a message integrity code (MIC) based at least on a secret key K, data compiled by the data source, and a data source identifier (ID);
transmit, from the data source to the operator, a message comprising at least the message integrity code (MIC), the data source identifier (ID) and the data;
transmit, from the client to the operator, a subscription request comprising the data source identifier (ID);
transmit, from the operator to the client, a request comprising: the data source identifier (ID), the data, and a set of integrity codes comprising the message integrity code (MIC) and at least one fake integrity code; and
transmit, from the client to the operator, a response comprising an indication of the presence, position, or value of the message integrity code within the set of integrity codes.

20. The system of claim 19, wherein the client is further caused to calculate a message integrity code (MIC) based at least on the secret key K associated with the data source identifier (ID), and the content of the request received from the operator.

21. The system of claim 19 or 20, wherein the client is further caused to store a set of at least one data source identifier (ID) and an associated secret key, K.

22. The system of any of claims 19-21, wherein the client is further caused to provision the data source with the secret key, K and the data source identifier (ID).

23. The system of any of claims 19-22, wherein the order of integrity codes within the set of integrity codes is randomized.

24. The system of any of claims 19-23, wherein the number of fake integrity codes within the set of integrity codes is based on a trust level (N) associated with at least one of: the data source and the client.

25. The system of any of claims 19-23, wherein the trust level (N) is changed based on the response from the client.

26. The system of claim 24 or 25, further comprising the step of either:
increasing N if the response from the client comprises an incorrect indication of the presence, position or value of the message integrity code, or
decreasing N if the response from the client comprises a correct indication of the presence, position or value of the message integrity code.

27. The system according to any of claims 24-26, wherein the trust level (N) is an integer, greater than 1, and the number of fake integrity codes is equal to N-1.

28. The system according to any of claims 24-27, wherein the trust level (N) has a maximum value M, and if N is increased above M the client is unsubscribed from the data source or the client is banned entirely.

29. A method for dataflow control in an operator of a low power wide area network (LPWAN), the method comprising the steps of:
receiving a subscription request from a client, the subscription request comprising a data source identifier (ID);
receiving a message comprising the data source identifier (ID), data, and a message integrity code (MIC);
transmitting a request to the client, the request comprising, the data source identifier (ID), the data, and a set of integrity codes comprising the message integrity code (MIC) and at least one fake integrity code; and
receiving a response from the client comprising an indication of the presence, position, or value of the message integrity code within the set of integrity codes.

30. The method according to claim 29 wherein the order of integrity codes within the set of integrity codes is randomized.

31. The method according claim 29 or 30 wherein the number of fake integrity codes within the set of integrity codes is based on a trust level (N) associated with at least one of: the data source and the client.

32. The method according to claim 31 wherein the trust level (N) is changed based on the response received from the client.

33. The method according to 31, further comprising the step of either:
increasing the trust level (N) if the received response from the client comprises an incorrect indication of the presence, position or value of the message integrity code, or
decreasing the trust level (N) if the received response from the client comprises a correct indication of the presence, position or value of the message integrity code.

34. The method according to and of claims 31-33, wherein the trust level (N) is an integer, greater than 1 and the number of fake integrity codes is equal to N-1.

35. The method according to 33, wherein the trust level (N) has a maximum value M, and if Nis increased above M the client is unsubscribed from the data source or the client is banned entirely.

36. The method according to any of claims 29-35, wherein the indication of the presence, position or value of the message integrity code within the set of integrity codes comprises the message integrity code itself.

37. The method according to any of claims 29-35, wherein the indication of the presence, position or value of the message integrity code within the set of integrity codes comprises a location of the message integrity code within the set of integrity codes.

38. The method according to any of claims 29-37, wherein the LPWAN operates using the LoRaWAN protocol.

39. The method according to any of claims 29-38, wherein the message is received from the data source.

40. A method for dataflow control in a client of a low power wide area network (LPWAN), the method comprising the steps of:
storing a set of at least one data source identifier (ID) and an associated secret key (K).
sending a subscription request to an operator comprising a data source identifier (ID);
receiving a request from the operator comprising a set of integrity codes;
calculating a message integrity code based at least on the secret key (K) associated with the data source identifier (ID), and the content of the request; and
transmitting a response to the operator comprising an indication of the presence, position or value of the message integrity code within the set of integrity codes.

41. The method of claim 40, wherein the request comprises the data source identifier (ID), the data, and the set of integrity codes.

42. The method according to claim 40 or 41, wherein the indication of the presence, position or value of the message integrity code within the set of integrity codes comprises the message integrity code itself.

43. The method according to any of claims 40-42, wherein the indication of the presence, position or value of the message integrity code within the set of integrity codes comprises a location of the message integrity code within the set of integrity codes.

44. A method for establishing trust and checking message integrity in a data source of a low power wide area network (LPWAN), the method comprising the steps of:
storing a secret key, K and a data source identifier (ID);
compiling data;
calculating a message integrity code based at least on the secret key K, the data and the data source identifier (ID); and
transmitting a message comprising at least the message integrity code (MIC), the data source identifier (ID) and the data.

45. The method of claim 44, wherein the secret key, K and the data source identifier (ID) are provisioned to the data source for storing.

46. The method of claim 45, wherein the secret key, K and the data source identifier (ID) are provisioned from a client device.

47. A method for dataflow control in a low power wide area network (LPWAN) comprising at least a data source, operator and client, the method comprising the steps of:
calculating, within the data source, a message integrity code (MIC) based at least on a secret key K, data compiled by the data source, and a data source identifier (ID);
transmitting, from the data source to the operator, a message comprising at least the message integrity code (MIC), the data source identifier (ID) and the data;
transmitting, from the client to the operator, a subscription request comprising the data source identifier (ID);
transmitting, from the operator to the client, a request comprising: the data source identifier (ID), the data, and a set of integrity codes comprising the message integrity code (MIC) and at least one fake integrity code; and
transmitting, from the client to the operator, a response comprising an indication of the presence, position, or value of the message integrity code within the set of integrity codes.

48. The method of claim 47, further comprising the step of the client calculating a message integrity code (MIC) based at least on the secret key K associated with the data source identifier (ID), and the content of the request received from the operator.

49. The method of claim 47 or 48, further comprising the step of storing, by the client, of a set of at least one data source identifier (ID) and an associated secret key, K.

50. The method of any of claims 47-49, further comprising the step of the client provisioning the data source with the secret key, K and the data source identifier (ID).

51. The method of any of claims 47-50, wherein the order of integrity codes within the set of integrity codes is randomized.

52. The method of any of claims 47-51, wherein the number of fake integrity codes within the set of integrity codes is based on a trust level (N) associated with at least one of: the data source and the client.

53. The method of any of claims 47-52, wherein the trust level (N) is changed based on the response from the client.

54. The method of claim 52 or 53, further comprising the step of either:
increasing N if the response from the client comprises an incorrect indication of the presence, position or value of the message integrity code, or
decreasing N if the response from the client comprises a correct indication of the presence, position or value of the message integrity code.

55. The method according to any of claims 52-54, wherein the trust level (N) is an integer, greater than 1, and the number of fake integrity codes is equal to N-1.

56. The method according to any of claims 52-55, wherein the trust level (N) has a maximum value M, and if N is increased above M the client is unsubscribed from the data source or the client is banned entirely.

57. A computer program configured to cause a method in accordance with at least one of claims 29-56 to be performed.

58. An operator of a low power wide area network (LPWAN), the operator comprising:
means for receiving a subscription request from a client, the subscription request comprising a data source identifier (ID);
means for receiving a message comprising the data source identifier (ID), data, and a message integrity code (MIC);
means for transmitting a request to the client, the request comprising, the data source identifier (ID), the data, and a set of integrity codes comprising the message integrity code (MIC) and at least one fake integrity code; and
means for receiving a response from the client comprising an indication of the presence, position, or value of the message integrity code within the set of integrity codes.

59. A client of a low power wide area network (LPWAN), the client comprising:
means for storing a set of at least one data source identifier (ID) and an associated secret key (K);
means for sending a subscription request to an operator comprising a data source identifier (ID);
means for receiving a request from the operator comprising a set of integrity codes;
means for calculating a message integrity code based at least on the secret key (K) associated with the data source identifier (ID), and the content of the request; and
means for transmitting a response to the operator comprising an indication of the presence, position or value of the message integrity code within the set of integrity codes.

60. A data source of a low power wide area network (LPWAN), the data source comprising:
means for storing a secret key, K and a data source identifier (ID);
means for compiling data;
means for calculating a message integrity code based at least on the secret key K, the data and the data source identifier (ID); and
means for transmitting a message comprising at least the message integrity code (MIC), the data source identifier (ID) and the data.

61. A system for dataflow control in a low power wide area network (LPWAN) comprising at least a data source, operator and client, the system comprising:
means for calculating, within the data source, a message integrity code (MIC) based at least on a secret key K, data compiled by the data source, and a data source identifier (ID);
means for transmitting, from the data source to the operator, a message comprising at least the message integrity code (MIC), the data source identifier (ID) and the data;
means for transmitting, from the client to the operator, a subscription request comprising the data source identifier (ID);
means for transmitting, from the operator to the client, a request comprising: the data source identifier (ID), the data, and a set of integrity codes comprising the message integrity code (MIC) and at least one fake integrity code; and
means for transmitting, from the client to the operator, a response comprising an indication of the presence, position, or value of the message integrity code within the set of integrity codes.

62. A non-transitory computer readable medium having stored thereon a set of computer readable instructions that, when executed by at least one processor, cause an operator of a low power wide area network (LPWAN) to at least:
receive a subscription request from a client, the subscription request comprising a data source identifier (ID);
receive a message comprising the data source identifier (ID), data, and a message integrity code (MIC);
transmit a request to the client, the request comprising, the data source identifier (ID), the data, and a set of integrity codes comprising the message integrity code (MIC) and at least one fake integrity code; and
receive a response from the client comprising an indication of the presence, position, or value of the message integrity code within the set of integrity codes.

63. A non-transitory computer readable medium having stored thereon a set of computer readable instructions that, when executed by at least one processor, cause a client of a low power wide area network (LPWAN) at least to:
store a set of at least one data source identifier (ID) and an associated secret key (K);
send a subscription request to an operator comprising a data source identifier (ID);
receive a request from the operator comprising a set of integrity codes;
calculate a message integrity code based at least on the secret key (K) associated with the data source identifier (ID), and the content of the request; and
transmit a response to the operator comprising an indication of the presence, position or value of the message integrity code within the set of integrity codes.

64. A non-transitory computer readable medium having stored thereon a set of computer readable instructions that, when executed by at least one processor, cause a data source of a low power wide area network (LPWAN) at least to:
store a secret key, K and a data source identifier (ID);
compile data;
calculate a message integrity code based at least on the secret key K, the data and the data source identifier (ID); and
transmit a message comprising at least the message integrity code (MIC), the data source identifier (ID) and the data.

65. A non-transitory computer readable medium having stored thereon a set of computer readable instructions that, when executed by at least one processor, cause a system comprising at least a data source, operator and client in a low power wide area network (LPWAN) at least to:
calculate, within the data source, a message integrity code (MIC) based at least on a secret key K, data compiled by the data source, and a data source identifier (ID);
transmit, from the data source to the operator, a message comprising at least the message integrity code (MIC), the data source identifier (ID) and the data;
transmit, from the client to the operator, a subscription request comprising the data source identifier (ID);
transmit, from the operator to the client, a request comprising: the data source identifier (ID), the data, and a set of integrity codes comprising the message integrity code (MIC) and at least one fake integrity code; and
transmit, from the client to the operator, a response comprising an indication of the presence, position, or value of the message integrity code within the set of integrity codes.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

1. An operator of a low power wide area network (LPWAN), the operator comprising at least one processing core, at least one memory including computer program code, the at least one memory and the computer program code being configured to, with the at least one processing core, cause the operator at least to:
receive a subscription request from a client, the subscription request comprising a data source identifier (ID);
receive a message comprising the data source identifier (ID), data, and a message integrity code (MIC);
transmit a request to the client, the request comprising, the data source identifier (ID), the data, and a set of integrity codes comprising the message integrity code (MIC) and at least one fake integrity code; and
receive a response from the client comprising an indication of the presence, position, or value of the message integrity code within the set of integrity codes.

2. The operator according to claim 1 wherein the order of integrity codes within the set of integrity codes is randomized.

3. The operator according to claim 1, wherein the number of fake integrity codes within the set of integrity codes is based on a trust level (N) associated with at least one of: the data source and the client.

4. The operator according to claim 3, wherein the trust level (N) is changed based on the response received from the client.

5. The operator according to claim 3, where the operator is further caused to:
increase the trust level (N) if the received response from the client comprises an incorrect indication of the presence, position or value of the message integrity code, or
decrease the trust level (N) if the received response from the client comprises a correct indication of the presence, position or value of the message integrity code.

6. The operator according to claim 3, wherein the trust level (N) is an integer and the number of fake integrity codes is equal to N-1.

7. The operator according to claim 5, wherein the trust level (N) has a maximum value M, and if N is increased above M the client is unsubscribed from the data source or the client is banned entirely.

8. The operator according to claim 1, wherein the indication of the presence, position or value of the message integrity code within the set of integrity codes comprises the message integrity code itself.

9. The operator according to claim 1, wherein the indication of the presence, position or value of the message integrity code within the set of integrity codes comprises a location of the message integrity code within the set of integrity codes.

10. The operator according to claim 1, wherein the LPWAN operates using the LoRaWAN protocol.

11. The operator according to claim 1, wherein the message is received from the data source.

12. A client of a low power wide area network (LPWAN), the client comprising at least one processing core, at least one memory including computer program code, the at least one memory and the computer program code being configured to, with the at least one processing core, cause the client at least to:
store a set of at least one data source identifier (ID) and an associated secret key (K);
send a subscription request to an operator comprising a data source identifier (ID);
receive a request from the operator comprising a set of integrity codes;
calculate a message integrity code based at least on the secret key (K) associated with the data source identifier (ID), and the content of the request; and
transmit a response to the operator comprising an indication of the presence, position or value of the message integrity code within the set of integrity codes.

13. The client of claim 12, wherein the request comprises the data source identifier (ID), the data, and the set of integrity codes.

14. The client according to claim 12, wherein the indication of the presence, position or value of the message integrity code within the set of integrity codes comprises the message integrity code itself.

15. The client according to claim 12, wherein the indication of the presence, position or value of the message integrity code within the set of integrity codes comprises a location of the message integrity code within the set of integrity codes.

16. A data source of a low power wide area network (LPWAN), the data source comprising at least one processing core, at least one memory including computer program code, the at least one memory and the computer program code being configured to, with the at least one processing core, cause the data source at least to:
store a secret key, K and a data source identifier (ID);
compile data;
calculate a message integrity code based at least on the secret key K, the data and the data source identifier (ID); and
transmit a message comprising at least the message integrity code (MIC), the data source identifier (ID) and the data.

17. The data source of claim 16, wherein the secret key, K and the data source identifier (ID) are provisioned to the data source for storing.

18. The data source of claim 17, wherein the secret key, K and the data source identifier (ID) are provisioned from a client device.

19. A system for dataflow control in a low power wide area network (LPWAN), the system comprising at least a data source, operator and client, each of said data source, operator and client comprising at least one processing core, at least one memory including computer program code, the at least one memory and the computer program code being configured to, with the at least one processing core, cause the system at least to:
calculate, within the data source, a message integrity code (MIC) based at least on a secret key K, data compiled by the data source, and a data source identifier (ID);
transmit, from the data source to the operator, a message comprising at least the message integrity code (MIC), the data source identifier (ID) and the data;
transmit, from the client to the operator, a subscription request comprising the data source identifier (ID);
transmit, from the operator to the client, a request comprising: the data source identifier (ID), the data, and a set of integrity codes comprising the message integrity code (MIC) and at least one fake integrity code; and
transmit, from the client to the operator, a response comprising an indication of the presence, position, or value of the message integrity code within the set of integrity codes.

20. The system of claim 19, wherein the client is further caused to calculate a message integrity code (MIC) based at least on the secret key K associated with the data source identifier (ID), and the content of the request received from the operator.

21.-25. (canceled)
